(19) United States
(12) Patent Application Publication
(10) Pub. No.: US 2021/0012339 A1
(43) Pub. Date: Jan. 14, 2021

(54) TECHNIQUES TO ELECTRONICALLY SHARE TRANSACTION CARD INFORMATION

(71) Applicant: Capital One Services, LLC, Mclean, VA (US)

(72) Inventors: Galen RAFFERTY, Mahomet, IL (US); Austin Grant WALTERS, Savoy, IL (US); Jeremy Edward GOODSITT, Champaign, IL (US); Anh TRUONG, Champaign, IL (US); Reza FARIVAR, Champaign, IL (US); Vincent PHAM, Champaign, IL (US)

(73) Assignee: Capital One Services, LLC, McLean, VA (US)

(21) Appl. No.: 16/505,064

(22) Filed: Jul. 8, 2019

(51) Int. Cl. G06Q 20/40; G06Q 20/34; G06Q 20/38

(52) U.S. Cl. CPC G06Q 20/409; G06Q 20/352; G06Q 20/405; G06Q 20/24; G06Q 20/4018; G06Q 2220/00; G06Q 20/3829

(57) ABSTRACT

Various embodiments are generally directed to techniques share transaction card information with another device. More specifically, embodiments discussed here include sharing transaction card information from one device to another device, such as a mobile phone or transaction card, such that a user of the other device may perform one or more authorized transactions.

### BACKGROUND

Today credit card users can use their cards at merchants across the country and around the world. Card issuers continue to work tirelessly to provide enhancements and new features. However, one drawback of the current card technology is that they are not easily shareable in a secure manner. Typically, a credit card user has to provide another user the physical credit card for that user to be able to use the card to make transactions, which can present a great deal of risk to both the user and the credit card issuer. Further, the user must trust the user that the card will be used in a manner promised by the other user, and may represent unauthorized use under the cardholder agreement. Embodiments discussed herein are directed to solving these problems.

### SUMMARY

Embodiments, as discussed herein, may include a computing device, a system, an apparatus, and so forth may include a processor circuit, a communication interface; and a memory storing instructions which when executed by the processor circuit, cause the processor circuit to perform operations. For example, embodiments may include the processor to determine, by an application operable on the processor circuit, a device associated with a first user with which to share transaction card information, the transaction card information comprising a number associated with an account of a second user, and the transaction card information capable for use to perform one or more transactions, determine, by the application, one or more restrictions to apply to usage of the transaction card information when shared with the device associated with the first user, communicate, by the application via the communications interface and with the device, the transaction card information, communicate, by the application, to a server the transaction card information and the one or more restrictions, the server associated with a provider of the transaction card information, and the provider enabled to approve the one or more transactions based, at least in part, on the one or more restrictions received from the application, and receive, by the application and from the device, a confirmation that the transaction card information was successfully shared with the device.

Embodiments may further include techniques and circuitry to perform the method including determining transaction card information to share with a device, wherein the device is associated with a first user, and the transaction card information comprising an account number associated with a second user, determining one or more restrictions for the transaction card information to apply during performance of one or more transactions, communicating the transaction card information and an indication of the one or more restrictions to the device associated with the first user, the device to utilize the indication of the one or more restrictions to enable performance of the one or more transactions, and receiving, from the device associated with the first user, a confirmation that the transaction card information and the indication of the one or more restrictions were successfully shared with the device.

Embodiments may also include techniques and circuitry to receive, via an input device, a user selection of an identifier of a first user, a telephone number associated with the first user, an email address associated with the first user, or any combination thereof, determine, by an application operable on the processor, a device associated with the first user based on the user selection and to share transaction card information, the transaction card information comprising a number associated with an account of a second user, and the transaction card information capable for use to perform one or more transactions, receive, by the application, a user selection of one or more restrictions to apply to usage of the transaction card information when shared with the device associated with the first user, communicate, by the application via a communications interface, the transaction card information to the device, communicate, by the application, to a server that the transaction card information is shared with the device, and receive, by the application and from at least one of the server and the device, a confirmation that the transaction card information was successfully shared with the device.

### BRIEF DESCRIPTION OF THE DRAWINGS

FIG. 1 illustrates an example of a transaction information sharing system.

FIG. 2 illustrates an example of a communication sequence for a transaction information sharing system.

FIGS. 3A/3B illustrates a second example of a communication sequence for a transaction information sharing system.

FIG. 4 illustrates an example of a processing flow for a transaction information sharing system.

FIG. 5 illustrates an example of a second processing flow for a transaction information sharing system.

FIG. 6 illustrates an example of a third processing flow for a transaction information sharing system.

FIG. 7 illustrates an example of a fourth processing flow for a transaction information sharing system.

FIG. 8 illustrates an example of a computing device.

FIG. 9 illustrates an example of a transaction card.

### DETAILED DESCRIPTION

Various embodiments are directed to electronically sharing transaction card information between devices. The transaction card information may be used by a user receiving the information to perform one or more transactions. In one example, a user may determine to share the transaction card information with another user via an application operating on a mobile device or computing device. The user may also cause the device to communicate the transaction card information to another device, either in a peer-to-peer (P2P) communications or through a network such as the Internet. Each of the users may then use the transaction card information to perform one or more transactions to purchase goods and/or services.

In some embodiments, the user may determine one or more restrictions to apply to the transaction card information shared with the other user and device. The one or more restriction may include restrictions on the location of use, time of use, amount of time of use, amount of use, and so forth. These and other details will become apparent in the following description.

Reference is now made to the drawings, wherein like reference numerals are used to refer to like elements throughout. In the following description, for purpose of explanation, numerous specific details are set forth in order to provide a thorough understanding thereof. It may be evident, however, that the novel embodiments can be practiced without these specific details. In other instances, well-known structures and devices are shown in block diagram form to facilitate a description thereof. The intention is to cover all modification, equivalents, and alternatives within the scope of the claims.

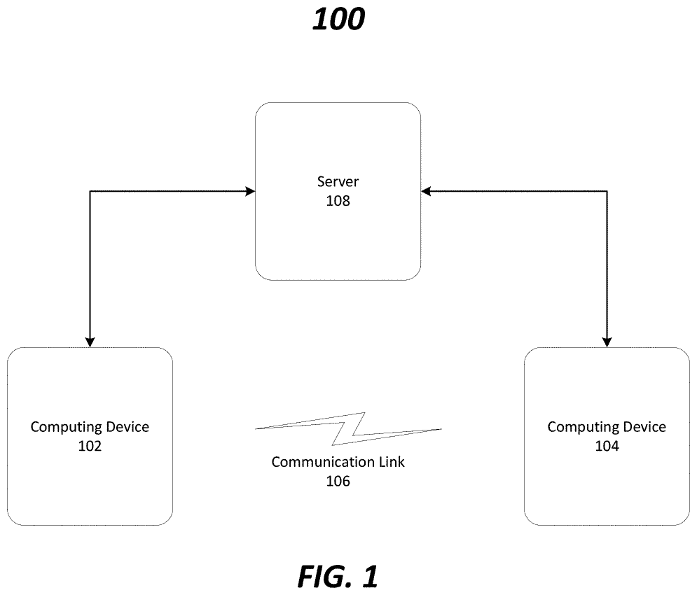

FIG. 1 illustrates a transaction information sharing system 100 according to embodiments discussed herein. As further discussed below, system 100 may include a first computing device 102, a second computing device 104, and, in some instances, a server 108. FIG. 1 illustrates a limited number of devices for simplistic purposes, and embodiments may include additional, systems, devices, components, and so forth, and be consistent with embodiments, discussed herein.

In embodiments, the computing devices 102 and 104 may be a mobile device; for example, the mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. However, embodiments are not limited in this manner, the computing devices 102 and 104 be another type of device, e.g., a communications device, a handheld personal computer (PC), a server, a network appliance, a personal computer (PC), a workstation, a personal digital assistant, a thin client, a fat client, and so forth. In some embodiments and will be discussed in more detail below, one or more of the first computing device 102 and the second computing device 104 may be a transaction card.

In some instances, the first and second computing devices 102 and 104 may be the same type of computing devices, e.g., each may both be a mobile device. In other instances, the first and second computing devices 102 and 104 may be different types of computing devices. For example, the first computing device 102 may be a mobile device, and the second computing device 104 may be a transaction card. Embodiments are not limited in this manner.

The computing devices 102 and 104 can include components, such as a processor and a memory, and it is understood that the processor may contain additional components, including processing circuitry, memories, error and parity/CRC checkers, data encoders, anti-collision algorithms, controllers, command decoders, security primitives, and tamper-proofing hardware, as necessary to perform the functions described herein. The computing devices 102 and 104 may further include a display and input devices. The display may be any type of device for presenting visual information such as a computer monitor, a flat panel display, and a mobile device screen, including liquid crystal displays (LCD), light-emitting diode displays, plasma panels, a touch-screen display, and so forth. The input devices may include any device for entering information into the user's device that is available and supported by the user's device, such as a touch-screen display, keyboard, mouse, cursor-control device, touch-screen, microphone, digital camera, video recorder or camcorder. These devices may be used to enter information and interact with the software and other devices described herein.

In embodiments, the computing devices 102 and 104 may include one or more input/output (I/O) devices, including those to communicate using wireless and wired technologies. For example, the computing devices 102 and 104 may include one or more transceivers to communicate in a cellular frequency band, e.g., a 700 Megahertz (MHz) frequency range, a 800 Megahertz (MHz) frequency range, a 850 MHz frequency range, a 1700 MHz frequency range, a 1900 MHz frequency range, a 2100 MHz frequency range, a 2300 MHz frequency range, a 2500 MHz frequency range, a 2600 MHz frequency range, and so forth. The transceiver itself may include components and circuitry to perform transmitting and receiving operations. The components and circuitry include analog-to-digital converters, digital-to-analog converters, modulators, amplifiers, and so forth. In embodiments, the transceiver may be coupled with one or more antennas to perform communications. Moreover, the transceiver may include and/or be coupled with the additional physical layer and Medium Access Control (MAC) layer circuitry and software to communicate in accordance with one or more cellular standards, such as the 2nd generation (2G), 3G, 4G, and 5G or New Radio (NR) standards. Additional cellular standards and/or techniques include Enhanced Data rates for GSM Evolution (EDGE), Evolution-Data Optimized (EVDO), General Packet Radio Service (GPRS), High Speed Packet Access (HSPA), Evolved HSPA (HSPA+), Long-Term Evolution (LTE), Universal Mobile Telecommunications System (UMTS), Worldwide Interoperability for Microwave Access (WiMAX), etc. The transceiver may utilize one or more radio technologies and protocols (cellular protocols), e.g., Code-division multiple access (CDMA), frequency-division duplexing (FDD), time-division duplexing (TDD), multiple-input and multiple-output (MIMO), Orthogonal frequency-division multiple access (OFDMA), and so forth. Embodiments are not limited in this manner.

In embodiments, the computing devices 102 and 104 may include additional I/O devices, such as an NFC device coupled with an NFC antenna, e.g., a loop antenna. The NFC device may be a radio/controller operable to communicate in accordance with the NFC protocol and to employ electromagnetic induction via the NFC antenna. In one example, the NFC device may communicate in the unlicensed radio frequency Industrial, Scientific, and Medical (ISM) band of 13.56 MHz on International Organization for Standardization/International Electrotechnical Commission (ISO/IEC) 18000-3 air interface achieving data rates from 106 to 424 kilobits/second (kbit/s). As will be discussed in more detail below, the NFC device may be employed and provided via an application to communicate with another NFC enabled device, e.g., a transaction card 105.

In one example, the first computing device 102 may be an initiator, and the second computing device 104 may be a target. In this example, the first computing device 102 and the second computing device 104 may operate in a passive mode of operation. The first computing device 102 operating as the initiator energizes and provides a carrier field for the second computing device 104 operating as the target. The second computing device 104 draws its operating power from the initiator-provided electromagnetic field. In embodiments, the first computing device 102, including the NFC device, may continuously and periodically (or semi-periodically) search for a target, e.g., the second computing device 104. In embodiments, the first computing device 102 may communicate signals, including data with the first computing device 102 in accordance with the NFC protocol. For example, the first computing device 102 may communicate transaction card information with the second computing device 104 to enable the second computing device 104 to utilize transaction card information of the user of the first computing device 102. Embodiments are not limited in this manner. In some embodiments, the second computing device 104 may be the initiator, and the first computing device 102 may be the target, for example.

In embodiments, one or more of the first computing device 102 and the second computing device 104 may include an application, such as a banking application, a transaction card application, a web browser to present a website associated with the transaction card/bank, and so forth. The application may be executable on a computing device and enable a user to interact and control one or more banking features. For example, the application may enable a user to view account information, edit personal account settings, transfer money to and from an account, pay a balance for an account, pay bills, and so forth. Further, the application may enable a user to share transaction card information associated with a transaction card with another user and their computing device. Thus, instead of the first user sharing their physical transaction with a second user, the transaction card information may be electronically communicated to a device of the second user, and the second user may use the device and transferred transaction card information to perform purchases.

In embodiments, the application may include a graphical user interface (GUI) presented on a display of the computing device and is configured to receive user inputs to control and interact with the one or more banking features. The GUI may enable a user to perform the one or more banking features, including transferring the transaction card information. In one example, the GUI may present information to enable a user to select a user to transfer the information, e.g., a contact list. The application may receive, via an input device, an indication of the selection of the user to transfer the information, e.g., a call made by an input device processing routine. Once the user selects another user to transfer to, the user may initiate the transfer via the GUI, e.g., a transfer button. Similarly, the application may receive, via the input device, an indication of the selection to transfer the transaction card information to a device associated with the selected user, e.g., a call made by an input processing routine. Embodiments are not limited to this example.

For example, a user of the first computing device 102 may determine to transfer transaction card information to a user of the second computing device 104. The first computing device 102, executing, the application, may receive a user selection via a touchscreen interface, a button input, a microphone, and so forth, of contact and another selection to share transaction card information with the computing device 104. The user selection may be used to determine the second computing device 104 to transfer transaction card information and include one or any combination of a user selection of an identifier of the user, a selection or entering of a telephone number associated with the user, a selection or entering of an email address of the user, a selection of an account identifier, or another identifier of the user. The transaction card information may include a transaction card account number, an expiration date of the transaction card, a user identifier for the transaction card, an address associated with the transaction card, a phone number associated with the transaction, and so forth. The application, via execution of instructions, may receive or retrieve the transaction card information from memory or storage, for example. The transaction card information is stored in a secure/encrypted memory location and may be retrievable via instructions of the application operating within a secure computing environment, e.g., utilizing cryptographic processing in accordance with ISO/IEC 11889. In some instances, the application may generate and/or communicate with server 108 to receive a virtual account number or token, that may be shared with a computing device. Thus, a user does not have to share their personal account number but may generate or have a virtual account number generated for a one-time sharing.

The application also enables users to set one or more restrictions for the shared transaction card information. For example, the user of the first computing device 102 may set a time limit, e.g., minutes, hours, days, etc., for which the transaction card information is shared with the other user of the second computing device 104 and the other use may utilize the information to make purchases. In another example, the user may also set an amount for which a user may spend. For example, the user may set a $400 cap that user may spend, and once the cap is reached, the shared transaction card information may no longer be used to make purchases. In embodiments, other restrictions may be applied by the user for the shared transaction card information, e.g., a location (within in certain area), a specific place of business, a specific user, a number of transactions limit, and so forth.

In embodiments, the user may set the restrictions for the transaction card information via one or more user interactions with the GUI. For example, the application may present one or more options or restrictions that the user may select via a user selection or interaction with the GUI, the selections may be detected via a user input device or touchscreen interface, and communicated via one or more calls or messages to the application. However, embodiments are not limited in this manner. In some instances, the restrictions may be pre-set, e.g., prior to the time of the transaction, and/or may be a default setting, e.g., set when the application is installed on the computing device and/or set by the developer of the application.

The restrictions may be communicated to the computing device receiving the shared transaction information, e.g., from the first computing device 102 to the second computing device 104. In this example, the second computing device 104 may enforce the restrictions. For example, the restrictions may include secure code that may execute on every attempt to use the transaction card information by the second computing device 104. The secure code may be based on and/or generated from the restrictions set on the first computing device 102. For example, the secure code may be configured to enforce a time limit, a location restriction, a usage restriction, and so forth. Thus, each time there is an attempt to perform a transaction with the shared transaction card information, the second computing device 104 may execute the secure code to enforce restrictions. If no restrictions are met, the second computing device 104 may enable the performance of the transaction.

In embodiments, the secure code may be secured based on a hash value originally generated by the first computing device 102 during the time of generation of the secure code and shared with the second computing device 104. Each time the secure code is executed, the second computing device 104 may ensure that the secure code is not tampered with based on the shared hash value, e.g., matching a hash value generated by the second computing device 104.

Once the user initiates the transfer, the first computing device 102, executing the application, may send the transaction card information to the second computing device 104 via communication link 106. In embodiments, the computing devices 102 and 104 may establish the communication link 106 between each other in accordance with a communication protocol, such as NFC, Bluetooth, IEEE 802.11, etc. In embodiments, the communication link 106 may be a secure communication link and the data, including the transaction card information, may be communicated securely. For example, the computing devices 102 and 104 may communicate over the communication link 106 utilizing encryption techniques. Thus, the transaction card information may be communicated from the first computing device 102 to second computing device 104 with little or no risk of an eavesdropping device obtaining the unencrypted data.

In some embodiments, one or more of the computing devices 102 and 104 of system 100 may also communicate with server 108. For example, a computing device 102 and/or 104 may be in communication with one or more servers 108 via one or more networks and may operate as a respective front-end to back-end pair with server 108. A computing device 102 and/or 104 may transmit, for example from application or code executing on the computing device, one or more requests to server 108. The one or more requests may be associated with receiving data from server 108 and providing data to the server 108. For example, a server 108 may receive the one or more requests from computing device 102 and/or 104 including an indication that transaction card information is shared or is to be shared between the computing device 102.

In embodiments, the computing device 102 and/or 104 may communicate with the server 108 to share transaction card information. In an example, the user of the first computing device 102 may share transaction card information with the second computing device 104, and utilize a virtual account number. The first computing device 102, based on a user request to share transaction card information, may send a request to server 108 to generate a virtual account number to share with the other computing device 104. The server 108 may generate the virtual account number, enable the virtual account number for use based on one or more restrictions, and provide the virtual account number to the first computing device 102. The first computing device 102 may share transaction card information, including the virtual account number with the second computing device 104. In other instances, the server 108 may generate the virtual account number, enable it for use, and provide it directly to second computing device 104. Note, as will be explained in more detail, a first computing device 102 may share transaction card information directly with the second computing device 104, e.g., via NFC, Bluetooth, IEEE 802.11, Infrared (IR) communication, sonic or sub-sonic communication, and so forth.

In embodiments, the computing devices 102 and/or 104 may send an indication of the transfer of the transaction card information to the server 108. For example, the first computing device 102 may send an indication to the server 108 notify of the transfer of the transaction card information along with the one or more restrictions. The server 108, based on the received indication and restrictions, may be enabled to permit transactions made by a user of the second computing device 104 which are in accordance with the restrictions. In other words, the server 108 may enforce the restrictions stipulated by the user of the first computing device 102. However, embodiments are not limited in this manner, and as discussed, the second computing device 104 may be enabled to enforce the restrictions of the shared transaction card information using the secure code.

In some embodiments, the server 108 may be coupled with a data store to store data and information with respect the computing devices 102 and 104. The server 108 may be part of a banking computer system operated by a bank, credit card issuer, credit union, or the like. The server 108 may store customer data associated with users or customers of the bank and banking computer system. For example, server 108 may maintain and/or have access to bank account information, transaction card information, user data, and so forth. The data store may be any type of data store, such as one or more databases stored on a local and/or remote storage system, a cloud-based data store system, and so forth.

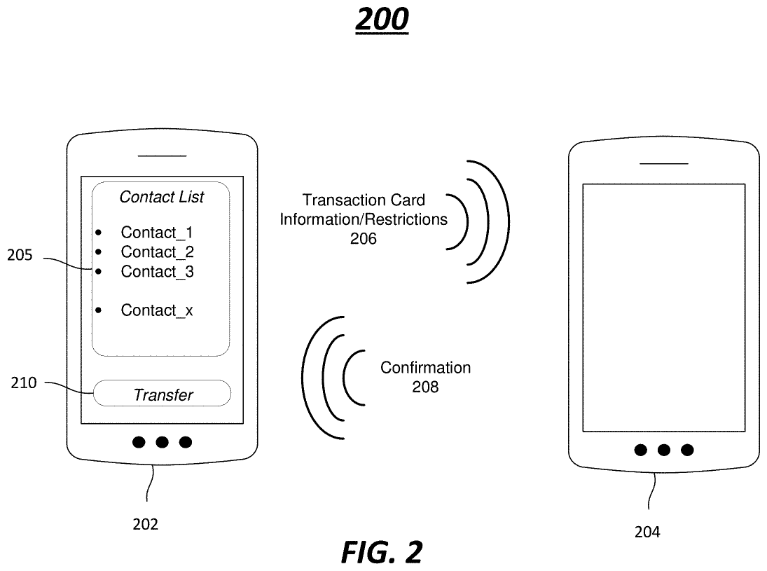

FIG. 2 illustrates an example of sequence flow 200 for a transaction information sharing system, including computing devices, such as a first mobile device 202 and a second mobile device 204. In the illustrated example, the first mobile device 202 is illustrated as sharing transaction card information with the second mobile device 204.

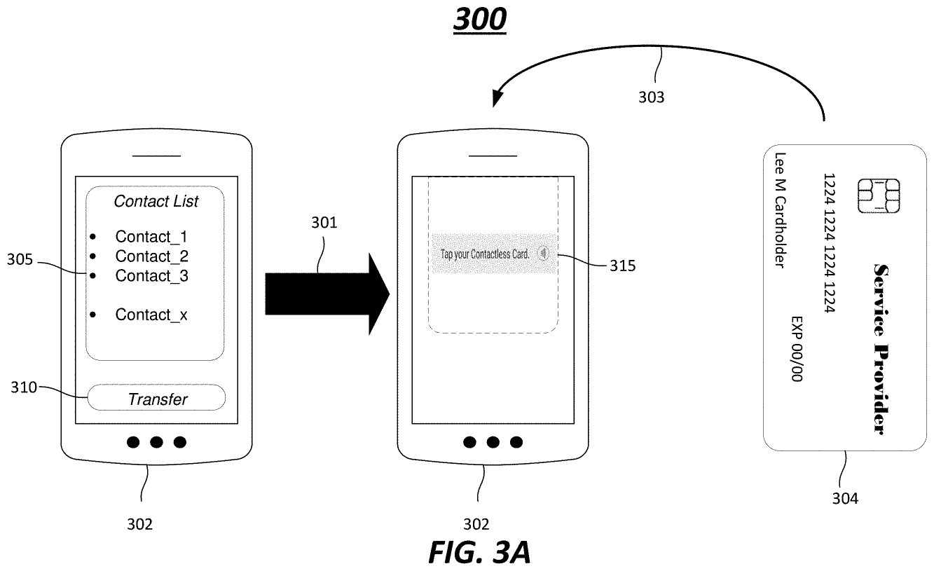

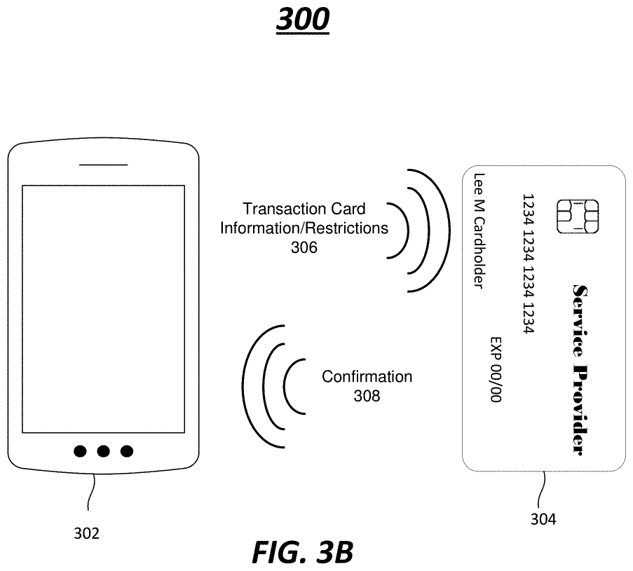

In embodiments, the first mobile device 202 determines or detects a request to share transaction card information with the second mobile device 204. For example, the first mobile device 202 may include an application configured to present a GUI on the display of the first mobile device 202 to control banking functions. In one example, a user may be presented with a GUI including a contact list 205 to enable a user to select another user/device to share the transaction card information. The first mobile device 202 may determine a device to share the transaction card information based on the user selection via an input device or touchscreen interface. Further, a user may select to share the transaction card information with a mobile device of the user (input 210), e.g., the second mobile device 204, however, in some instances and as will discussed in FIGS. 3A/3B, the user may select to share the transaction card information with a transaction card of the other user.

In embodiments, the first mobile device 202 may determine the transaction card information to share with the second mobile device 204. More specifically, a user may store transaction card information for several different transaction cards, and the user may select transaction card information associated with a particular transaction card to share with the other user and second mobile device 202. Each transaction card and/or corresponding transaction card information may be displayed in the GUI, and a user may make a selection via an input device or a touchscreen interface.

The first mobile device 202 may also determine one or more restrictions for the shared transaction card information. As mentioned, the user of the first mobile device 202 may set one or more restrictions on the use of the transaction card information being shared and/or the one or more restrictions may be preset or default settings.

In embodiments, the first mobile device 202 may establish a connection with the second mobile device 204. The connection may be a wireless connection, as previously discussed and include one or more channels to communicate securely, e.g., encrypted. The first mobile device 202 may send the transaction card information and/or the one or more restrictions to the second mobile device 204 at 206. The information and restrictions may be encrypted and communicated to the second mobile device 204 using a wireless communication technique, such as Bluetooth, NFC, IEEE 802.11, IR, Sonic, and so forth. Moreover, the information and restrictions may be communicated by the first mobile device 202 in one or more messages and/or packets to the second mobile device 204 and utilize secure communication techniques.

The second mobile device 204 may receive the transaction card information and restrictions and process the information and restriction to enable a user of the second mobile device 204. In some instances, the second mobile device 204, may be executing an application including computing instructions that may receive an indication of the reception of information and restrictions, e.g., a call or message from the operating system. The application, executing on the second mobile device 204, may perform one or more cryptographic operations on the information and restrictions, e.g., decryption, authentication, and verification. Once decrypted and authenticated, the second mobile device 204, including the application, may send a confirmation to the first mobile device 202 at 208.

The second mobile device 204 and application may enable the user to make one or more transactions using the shared transaction card information while enforcing the one or more restrictions. As previously discussed, the application may receive the one or more restrictions and enforce the restrictions. In some instances, the received one or more restrictions may include instructions to enforce the restrictions. For example, the one or more restrictions may be secure code provided by the first computing device 202 and executed when a transaction using the shared transaction card information is attempted.

In some embodiments, as previously discussed, the first mobile device 202 and second mobile device 204 may utilize a server, such as a server 108, to permit transaction in accordance with the one or more restrictions each time a user attempts to perform a transaction. For example, the second mobile device 204 and/or point-of-sale (POS) may communicate with the server details of the transaction, and the server may make a determination based on provided restrictions and the shared transaction information as to whether to permit or deny the transaction. The decision may be provided to the POS and/or the second mobile device 204.

Once the restrictions are met, e.g., a time period expired, the second mobile device 204, including the application may disable utilization of the transaction card information. In some instances, the server may disable the utilization of the transaction card information based on one or more restrictions.

FIGS. 3A/3B illustrates an example of a sequence flow 300 for a transaction information sharing system, including computing devices, such as a mobile device 302 and transaction card 304. In the illustrated example, the mobile device 302 is illustrated as sharing transaction card information with the transaction card 304.

In embodiments, the mobile device 302 determines or detects a request to share transaction card information with the transaction card 304. For example and as similarly discussed above, a user may be presented with a GUI including a contact list 305 to enable a user to select another user/device to share the transaction card information. In embodiments, the user may select a specific user and then an associated device, e.g., transaction card 304, or may just select the device.

In embodiments, the mobile device 302 may determine the transaction card information to share with the transaction card 304. More specifically, a user may store transaction card information for a number of different transaction cards, and the user may select transaction card information associated with a particular transaction card to share with the other user and transaction card 304. Each available transaction card information to share may be displayed in the GUI, and a user may make a selection via an input device or a touchscreen interface, for example.

The mobile device 302 may also determine one or more restrictions for the shared transaction card information. The user of the mobile device 302 may set one or more restrictions on the use of the transaction card information being shared and/or the one or more restrictions may be preset or default settings.

In embodiments, the mobile device 302 may establish a connection with the transaction card 304. The connection may be a wireless connection, as previously discussed and include one or more channels to communicate in a secure fashion, e.g., encrypted.

In some embodiments, the mobile device 302 may instruct a user to tap and/or present the transaction card 304 on the touchscreen display at 301. For example, the mobile device 302 may display an indication and/or outline of a transaction card as indicated by indicator 315. The indication may instruct a user to place the transaction card 304 on the touchscreen display. At 303, a user may place the transaction card 304 on and/or near the mobile device 302, and one or more security operations may be performed to establish a connection between the mobile device 302 and the transaction card 304, as discussed in U.S. patent application Ser. No. 16/205,199, filed Nov. 29, 2018, and incorporated by reference herein. The mobile device 302 and transaction card 304 may utilize one or more NFC communications, including identifying information to authenticate and validate the transaction card 304 by the mobile device 302. Embodiments are not limited in this manner, and other exchange techniques may be used, e.g., based on the protocol used to communicate between the mobile device 302 and the transaction card 304.

In embodiments, the mobile device 302 may send the transaction card information and/or the one or more restrictions to the transaction card 304 at 306 in FIG. 3B. In some instances, the user may interface with an input 310 to cause the transfer to the other device. However, in other instances, the transfer may happen automatically once the NFC communication channel is established. The information and restrictions may be encrypted and communicated to the transaction card 304 using a wireless communication technique based on the established communication, e.g., Bluetooth, NFC, IEEE 802.11, IR, Sonic, and so forth. Moreover, the information and restrictions may be communicated by the mobile device 302 in one or more messages and/or packets to the transaction card 304 and utilize secure communication techniques.

The transaction card 304 may receive the transaction card information and restrictions and process the information and restriction to enable a user of the transaction card 304. In some instances, the transaction card 304, may be executing an application and/or instructions that may receive an indication of the reception of information and restrictions. The application, executing on the transaction card 304, may perform one or more cryptographic operations on the information and restrictions, e.g., decryption, authentication, and verification. Once decrypted and authenticated, the transaction card 304, including the application, may enable the transaction card information for use by storing the information in secure memory. In some instances, the transaction card 304 may send a confirmation back to the mobile device 302 at 308. The transaction card 304 may cause the performance of a transaction using the shared transaction card information until a restriction is met and/or the sharing is terminated. The transaction card 304 may store the original transaction card information in secure memory and revert to using the original transaction card information once the shared transaction card information can no longer be used.

In some embodiments, as previously discussed, the mobile device 302 and transaction card 304 may utilize a server, such as a server 108, to permit transaction in accordance with the one or more restrictions each time a user attempts to perform a transaction. For example, the transaction card 304 and/or point-of-sale (POS) may communicate with the server details of the transaction, and the server may decide based on provided restrictions and the shared transaction information as to whether to permit or deny the transaction. The decision may be provided to the POS and/or the transaction card 304.

Once the restrictions are met and/or sharing is terminated, e.g., a time period expired, the transaction card 304, including the application may disable utilization of the transaction card information and the original transaction card information may be reverted for use. In some instances, the server may disable the utilization of the shared transaction card information based on the one or more restrictions.

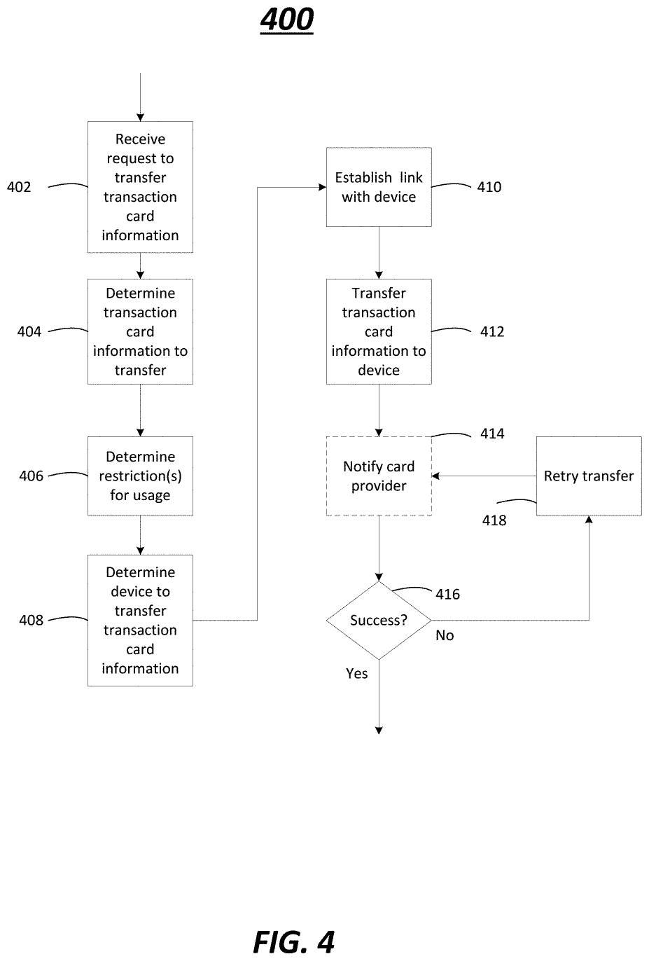

FIG. 4 illustrates an example of a logic flow 400 to share transaction card information between devices. Embodiments are not limited in this manner.

At block 402, a device, such as a mobile device including circuitry executing an application, may determine or receive a request to transfer transaction card information to another device, such as another mobile device or a transaction card. Note that in some instances, the device sharing the transaction card information may be a device other than a mobile device, such as a PC through a website in a web browser, a financial institution server/computer executing an application and operated by a bank employee, a call center server executing an application and operated by a bank employee or agent, and so forth.

At block 404, the device may determine the transaction card information to share with the other device. For example, a user of the device may make a selection of specific transaction card information from a plurality of different transaction cards and corresponding information stored on the device and/or on a server and associated with the user. Moreover, the device may determine one or more locations of memory storing the transaction card information and retrieve the information from the memory.

At block 406, the device may determine one or more restrictions to apply to the shared transaction card information. As previously discussed, the one or more restrictions may be different each time that the transaction card information is shared and may be chosen by a user of the device. In other instances, the restrictions may be preset and/or default restrictions. Embodiments are not limited in this manner, and the one or more restrictions may be configurable via the device, a bank employee via a banking server or computer, a call center via a server and secure access to a banking system, and so forth.

AT block 408 the device may determine the other device to share the transaction card information. For example, a user may select a contact (phone number, name, email address, a social media username, etc.) and/or a device associated with the other user via a GUI of the device.

At block 410, the device may establish a link with the other device to communicate the shared transaction card information. For example, the device may send one or more messages to authenticate and connect with the other device wirelessly in accordance with a wireless protocol, such as Bluetooth, NFC, IEEE 802.11, IR, sonic, etc. In some instances, the other device may be a transaction card, and the device may prompt a user of the transaction card to place the transaction card on or near the display of the device to perform authentication, e.g., via NFC. In another example, the device may be a server and may also establish a connection via a network, such as the Internet, that may include one or more wired and wireless connections including networking wires, components, switches, routers, and so forth.

At block 412, the device may communicate the transaction card information to the other device via the established communication link. In some instances, the device may also send the one or more restrictions to the other device such that the other device may enforce the one or more restrictions on the transaction card information and usage. The communication may be one or more transmissions and including sending one or more packets and/or messages in accordance with the protocol utilized for the established communication link. The information and restrictions may also be encrypted to and/or use encrypted communication channels to ensure that the sensitive data is not compromised.

In some instances, the transaction card information may be shared with the other device transparently to the banking system of the provider of the transaction card. Thus, the user of the other device may utilize the transaction card information to make purchases with the shared transaction card information while also enforcing the restrictions. The banking system may process the transactions and have no knowledge of the shared transaction card information. However, at optional block 414, the device may notify the transaction card provider of the shared transaction card information. For example, the device may send an indication to a server of a banking system associated with the provider of the transaction card information. The indication may include details of the shared transaction card information, e.g., date, time, location, user, another device identifier, etc. and about the one or more restrictions applied to the shared transaction card information. The server may utilize this information to enforce the one or more restrictions while processing transactions using the shared transaction card information. For example, a server may receive an indication of a transaction using the transaction card information, e.g., from a POS terminal via POS network. The server may then determine one or more restrictions applied to the shared transaction card information, e.g., by performing a lookup in a database storing the restrictions, and apply the one or more restrictions to the transaction to either permit or deny the transaction. The server may communicate a result indicating permission or denial of the transaction via the POS network.

At decision block 416, the device may determine whether sharing the transaction card information with the other device was successful or unsuccessful. For example, the device may receive a confirmation from one or more of the other device and/or the server indicating that the transaction card information was successfully or unsuccessfully shared, e.g., via the established communication link and/or a link established with the server. The device may not receive any indication from one or more of the other device and/or server, the device may determine the sharing attempt was unsuccessful. If the attempt to share was unsuccessful, the device may retry the transfer at block 418. The device may retry until the sharing is successful and/or a max number of attempts is reached.

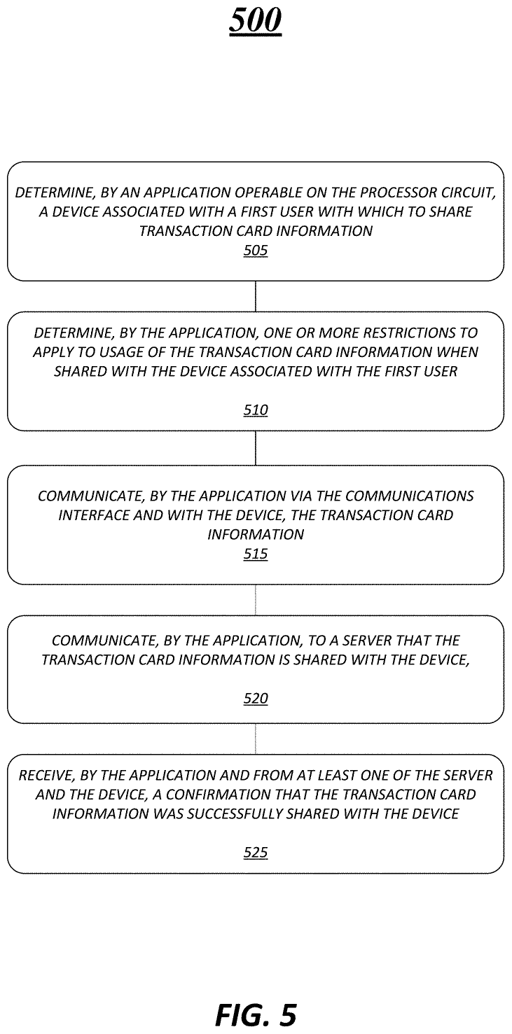

FIG. 5 illustrates an example of a logic flow 500 that may be representative of some or all the operations executed by one or more embodiments described herein. For example, the logic flow 500 may illustrate operations to share transaction card information.

At block 505, the logic flow 500 includes determining, by an application operable on the processor circuit, a device associated with a first user with which to share transaction card information, the transaction card information comprising a number associated with an account of a second user, and the transaction card information capable for use to perform one or more transactions.

At block 510, the logic flow 500 includes determining, by the application, one or more restrictions to apply to the usage of the transaction card information when shared with the device associated with the first user. Further and at block 515, the logic flow includes communicating, by the application via the communications interface and with the device, the transaction card information.

At block 520, the logic flow 500 includes communicating, by the application, to a server the transaction card information and the one or more restrictions, the server associated with a provider of the transaction card information, and the provider enabled to approve the one or more transactions based, at least in part, on the one or more restrictions received from the application. Further and at block 525, the logic flow includes receiving, by the application and from the device, a confirmation that the transaction card information was successfully shared with the device. In embodiments, a user of the device may utilize the shared transaction card information to perform one or more transactions based on the one or more restrictions.

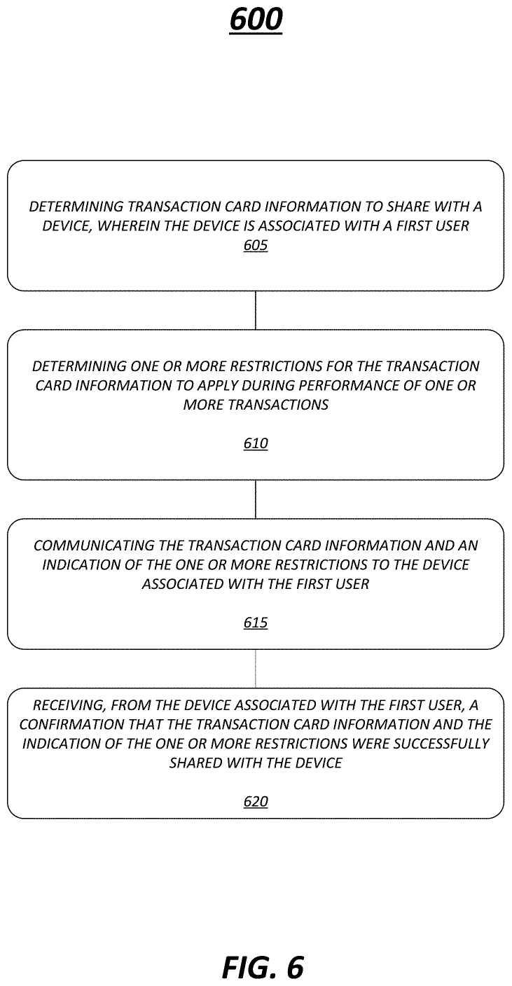

FIG. 6 illustrates an example of a logic flow 600 that may be representative of some or all the operations executed by one or more embodiments described herein. For example, the logic flow 600 may illustrate operations to share transaction card information.

The logic flow 600, at block 605 may include determining transaction card information to share with a device, wherein the device is associated with a first user, and the transaction card information comprising an account number associated with a second user. Further and at block 610 the logic flow 600 includes determining one or more restrictions for the transaction card information to apply during the performance of one or more transactions

At block 615, the logic flow 600 includes communicating the transaction card information and an indication of the one or more restrictions to the device associated with the first user, the device to utilize the indication of the one or more restrictions to enable performance of the one or more transactions. At block 620, the logic flow includes receiving, from the device associated with the first user, a confirmation that the transaction card information and the indication of the one or more restrictions were successfully shared with the device.

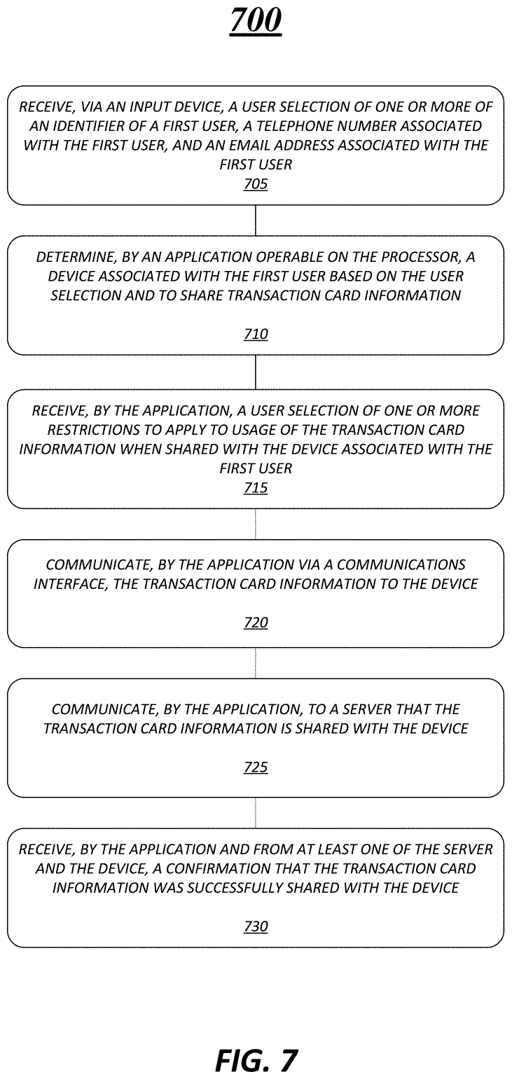

FIG. 7 illustrates an example of a logic flow 700 that may be representative of some or all the operations executed by one or more embodiments described herein. For example, the logic flow 700 may illustrate operations to share transaction card information.

At block 705, the logic flow 700 includes receiving, via an input device, a user selection of one or more of an identifier of a first user, a telephone number associated with the first user, and an email address associated with the first user.

At block 710, the logic flow 700 includes determining, by an application operable on the processor, a device associated with the first user based on the user selection and to share transaction card information, the transaction card information comprising a number associated with an account of a second user, and the transaction card information capable for use to perform one or more transactions.

At block 715, the logic flow 700 includes receiving, by the application, a user selection of one or more restrictions to apply to the usage of the transaction card information when shared with the device associated with the first user;

At block 720, the logic flow 700 includes communicating, by the application via a communications interface, the transaction card information to the device. Further and at block 725, the logic flow 700 includes communicating, by the application, to a server that the transaction card information is shared with the device.

The logic flow 700, at block 730, includes receiving, by the application and from at least one of the server and the device, a confirmation that the transaction card information was successfully shared with the device.

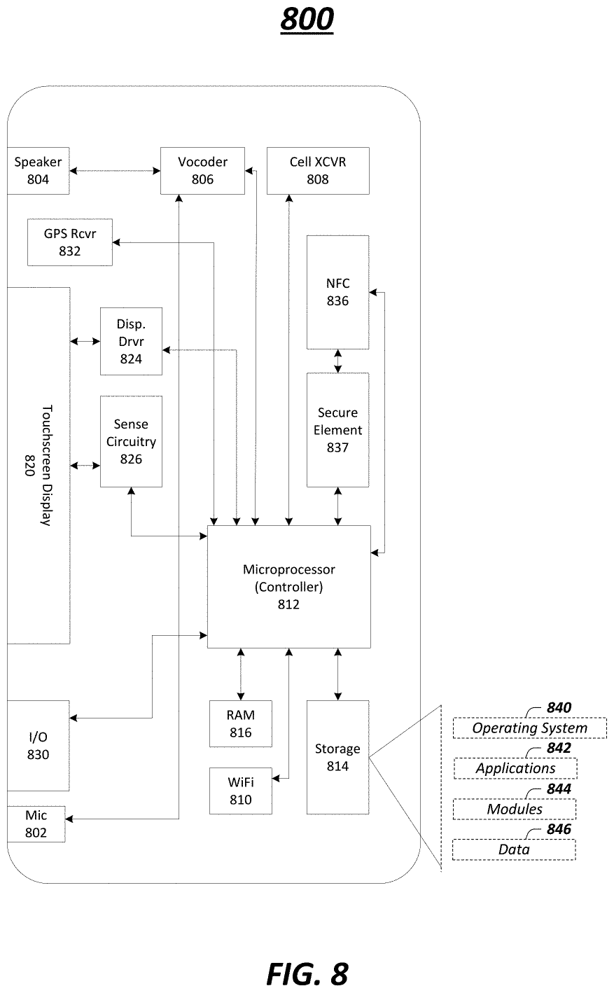

FIG. 8 illustrates an example of a computing device 800. Reference now is made in detail to the examples illustrated in the accompanying drawings and discussed below. FIG. 1 illustrates a mobile device 800, including a number of components. Further, the mobile device 800 may be configured to communicate in accordance with one or more wireless protocols, including NFC. For example, to provide data to or receive information from another mobile device or transaction card. In an example process, the following operations may take place. At a high level, the user brings the NFC enabled mobile device 800 within proximity (e.g., 2 to 4 cm or less, although in some cases the distance may be up to 20 cm) of another NFC capable device. An application installed on the mobile device 800 listens for NFC events and commences a contactless data flow by establishing communication with the other NFC capable device.

For example, in the peer-to-peer mode of operation, the mobile device 800 initiates a data exchange with another device (e.g., second NFC enabled mobile device). Such data exchange is defined in the ISO 18092 standard. Both devices play a symmetric role in that both may generate a magnetic field and transmit and receive data. A typical use case for P2P communication is the exchange of the transaction card information and one or more restrictions. Traditionally, such exchange is controlled by the host controller 812, without the involvement of a security function, leaving the recipient of a payload potentially vulnerable to malware. However, embodiments include the NFC controller 836 of the mobile device 800 to first determine whether a security function is required, e.g., cryptographic operations performed on the data for sending and receiving. If a security function is required, the payload, such as the transaction card information and/or one or more restrictions, is evaluated by the rule-set of the security element 837 before routing the information in the payload to the host controller 812 and communicating to the other device. The SE 837 may apply one or more encryption techniques before sending the data to the other device and NFC controller 836.

Similarly, the SE 837 may apply one or more decryption techniques on data received from the other device. In some embodiments, the SE 837 may be implemented in secure circuitry, as discussed herein. Further and although shown separately, the SE 837 may be implemented as part of the Microprocessor 812.

It should be appreciated that the disclosed subject matter may be implemented using any mobile computing device having NFC communication capability and mobile communication capability, configured to use those capabilities to conduct mobile transactions, e.g. for data exchange, as discussed herein. In the example of FIG. 8, the mobile device 800 is in the form of a smart phone type mobile handset, including a touch screen display 820. Examples of touch screen type mobile devices that may be used to implement mobile device 800 may include (but are not limited to) a smart phone, personal digital assistant (PDA), tablet computer or another portable device with NFC capability. However, the structure and operation of the touch screen type mobile device 800 is provided by way of example; and the subject technology as described herein is not intended to be limited thereto. For purposes of this discussion, FIG. 8 provides a block diagram illustration of the exemplary mobile device 800 having a touch screen display for displaying content and receiving user input as (or as part of) the user interface, e.g., selections of a user/device to send transaction card information, apply one or more restrictions, communicate with a banking system, and so forth.

In embodiments, the mobile device 800, also supports voice communications. Hence, in the example shown in FIG. 8, the mobile device 800 includes a microphone 802 for audio signal input and a speaker for audio signal output. The microphone 802 and speaker 804 are communicatively coupled to a voice or audio encoder/decoder (vocoder) 806. For a voice telephone call, for example, the vocoder 806 provides two-way conversion between analog audio signals representing speech or other audio and digital samples at a compressed bit rate compatible with the digital protocol of wireless telephone network communications or voice over packet (e.g., Internet Protocol) communications. The vocoder, speaker, and microphone may also be used as elements of the user interface during other operations of the device, including some types of transaction communications.

Also, as shown in FIG. 8, the mobile device 800 includes at least one digital transceiver (XCVR) 808, for digital wireless communications via a wide area wireless mobile communication network, although the mobile device 800 may include additional digital or analog transceivers (not shown). The transceiver 808 conforms to one or more of the various digital wireless communication standards utilized by modern mobile networks. Examples of such transceivers include (but are not limited to) transceivers configured to operate in accordance with Code Division Multiple Access (CDMA) and 3rd Generation Partnership Project (3GPP) network technologies including, for example and without limitation, 3GPP type 2 (or 3GPP2) and 3GPP Long Term Evolution (LTE), at times referred to as “4G.” For example, transceiver 808 provides two-way wireless communication of information including digitized audio signals, still image and/or video signals, web page information for display as well as web related inputs, and various types of mobile message communications to/from the mobile device 800.

In one example, the transceiver 808 also sends and receives a variety of signaling messages in support of various voice and data services provided by a network of a wireless service provider, to a user of mobile device 800 via the mobile communication network. Transceiver 808 connects through radio frequency (RF) send-and-receive amplifiers (not separately shown) to an antenna 809. Transceiver 808 may also support various types of mobile messaging services, such as short message service (SMS), enhanced messaging service (EMS), and/or multimedia messaging service (MMS). Although communications involving transaction card information and restrictions obtained from the NFC enabled device typically utilize IP data transport, such transaction communications may at times utilize one or more of these mobile messaging services for the data transport through the mobile communication network.

Many modern mobile devices also support wireless local area network communications over WiFi, instead of or in addition to data communications using the wide area mobile communication network. Hence, in the example of FIG. 8, for packet data communications, the exemplary mobile device 800 may also include a WiFi transceiver 810 and associated antenna 811. Although WiFi is used here as the example, the transceiver 810 may take the form of any available two-way wireless local area network transceiver of a type that is compatible with one or more standard protocols of communication implemented in wireless local area networks, such as one of the WiFi standards under IEEE 802.11 and/or WiMAX. The transceiver 8110, for example, may provide two-way data transport for wireless communication with a wireless access point in a residence or enterprise that the user frequents or with any available hotspot offered in a public venue. Although communicating through a different network or networks, the transceiver 810 supports various types of data communications similar to the packet data communications supported via the mobile network transceiver 808, including communications related to shared transaction card data, the one or more restriction, involving data communicated with the NFC enabled device, and a server of a banking system.

The mobile device 800 further includes a microprocessor, sometimes referred to herein as the host processor, which serves as a programmable controller for mobile device 800 by configuring mobile device 800 to perform various operations, for example, in accordance with instructions or programming executable by processor 812. For example, such operations may include various general operations of the mobile device 800 as well as operations related to sharing transaction card information, as discussed herein. A storage 814 is used to store, for example, programming or instructions for execution by the processor 812. Depending on the type of device, the mobile device 800 stores and runs an operating system through which specific applications may be run on the device. Examples of operating systems include Android, Apple iOS (I-Phone or iPad devices), Windows Mobile, RIM BlackBerry operating system, or the like. Storage 814 may also be used to store mobile configuration settings for different mobile applications or services executable at mobile device 800 (using processor 812), such as defaults/preset settings of a banking application. Mobile device 800 may also include a non-volatile random access memory (RAM) 816 for a working data processing memory. In embodiments, the storage 814 may include 840 an operating system 840, one or more applications 842, modules 844, and data 846 to perform functions discussed herein.

Other storage devices or configurations may be added to or substituted for those in the example. Such other storage devices may be implemented using any type of storage medium having computer or processor readable instructions or programming stored therein and may include, for example, any or all of the tangible memory of the computers, processors or the like, or associated modules. The instructions or programming may be used to implement the interaction with another device and/or server, as described herein. Program aspects of the technology may be thought of as “products” or “articles of manufacture” typically in the form of executable code or process instructions and/or associated data that is stored on or embodied in a type of machine or processor readable medium.

A mobile device supporting read/write, P2P, and card emulation and related data communications of the type under consideration here, may include a variety of different types of user interface elements. For discussion purposes, in the smart phone example shown in FIG. 8, the user interface elements of mobile device 800 include a touch screen display 820 (also referred to herein as “touch screen” or “display” or “touchscreen interface”). For output purposes, the touch screen 820 includes a display screen, such as a liquid crystal display (LCD) or the like. For input purposes, touch screen display 820 includes a plurality of touch sensors 822. Other interface elements may include a keypad including one or more keys 830. For example, the keypad may be implemented in hardware as a T9 or QWERTY keyboard of mobile device 800 and keys 830 may correspond to the physical keys of such a keyboard. Alternatively, keys 830 (and keyboard) of mobile device 800 may be implemented as “soft keys” of a virtual keyboard graphically represented in an appropriate arrangement via touch screen display 820. The soft keys presented on the touch screen display 820 may allow the user of mobile device 800 to invoke the same user interface functions as with the physical hardware keys. In some implementations, the microphone 802 and speaker 804 may be used as additional user interface elements, for audio input and output, including with respect to some functions related to the transaction processing and communication, as described herein.

For output, touch screen display 820 is used to present information (e.g., text, video, graphics or other visible content) to the user of mobile device 800, e.g., interact with a banking application. Host processor 812 controls visible display output on the LCD or other display element of the touch screen display 820 via a display driver 824, to present the various visible outputs to the device user. For example, some of the transaction related programming may cause the processor 812 to operate the driver 824 to cause screen 820 to display visible information about sharing transaction card information.

In general, touch screen display 820 and touch sensors 822 (and one or more keys 830, if included) are used to provide the textual and graphical user interface for the mobile device 800. In an example, touch screen display 820 provides viewable content to the user at mobile device 800. Touch screen display 820 also enables the user to interact directly with the viewable content provided in the content display area, typically by touching the surface of the screen with a finger or an implement such as a stylus.

As shown in FIG. 8, the mobile device 800 also includes a sense circuit 826 coupled to touch sensors 822 for detecting the occurrence and relative location/position of each touch with respect to a content display area of touch screen display 820. In this example, sense circuit 826 is configured to provide processor 812 with touch-position information based on user input received via touch sensors 822, which may be further provided to an operating system and application running on the operating systems. In some implementations, processor 812 is configured to correlate the touch position information to specific content being displayed within the content display area on touch screen display 820. The touch-position information captured by sense circuit 826 and provided to processor 812 may include, but is not limited to, coordinates identifying the location of each detected touch with respect to the display area of touch screen display 820 and a timestamp corresponding to each detected touch position.

The user interface capabilities of the mobile device 800 provide output to and receive input from the user of the mobile device 800, for any of the various functions, operations or applications of the device. For example, programming (discussed herein) that causes the mobile device 800 to obtain and act on information communicate with another device to share transaction card information.

The mobile device 800 location determining devices. In our example, the mobile device 800 includes a global positioning satellite (GPS) receiver 832 and associated antenna 834. GPS is a space-based satellite navigation system that provides location and time information anywhere on Earth, where there is an unobstructed line of sight to at least three, or more of the GPS satellites.

As previously discussed, the mobile device 800 also has NFC communication capability. NFC may be used for a variety of different functions or applications of the mobile device 800. Although cryptographic elements are not separately shown, the NFC chip 836 and 837 is also configured such that transmissions are encrypted/decrypted. Accordingly, the secure data storage and encrypted communication provide enhanced security and reduce the likelihood of fraud against a user's financial account. The structure and operation of the mobile device 800, as outlined above, were described to by way of example, only.

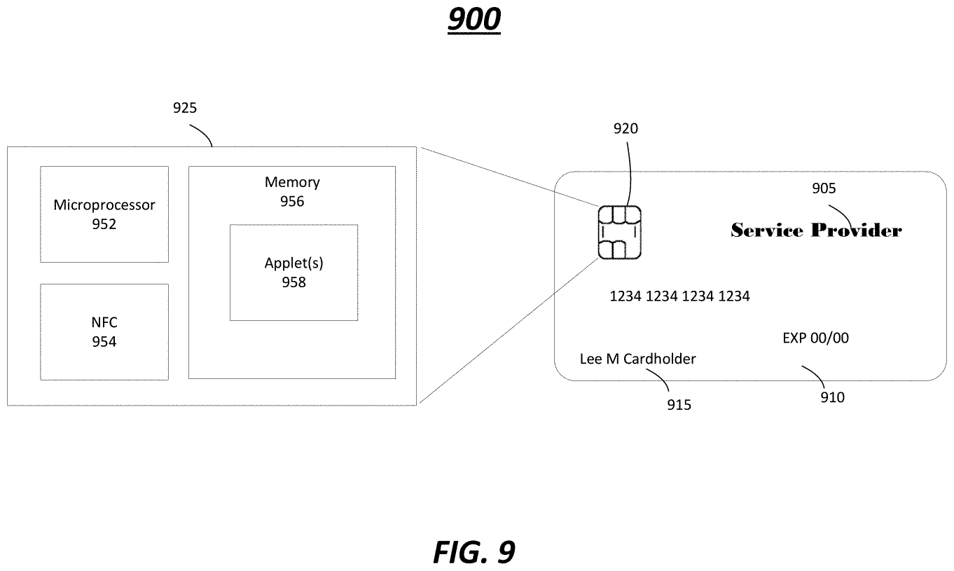

FIG. 9 illustrates an example of a transaction card 900, which may include a contactless card, a payment card, such as a credit card, debit card, or gift card, issued by a service provider as displayed as service provider indicia 905 on the front or back of the card 900. In some examples, the transaction card 900 is not related to a payment card, and may include, without limitation, an identification card. In some examples, the transaction card may include a dual interface contactless payment card, a rewards card, and so forth. The transaction card 900 may include a substrate 910, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the transaction card 900 may have physical characteristics compliant with the ID-1 format of the ISO/IEC 7816 standard, and the transaction card may otherwise be compliant with the ISO/IEC 14443 standard. However, it is understood that the transaction card 900 according to the present disclosure may have different characteristics, and the present disclosure does not require a transaction card to be implemented in a payment card.

The transaction card 900 may also include identification information 915 displayed on the front and/or back of the card, and a contact pad 920. The contact pad 920 may include one or more pads and be configured to establish contact with another computing device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The transaction card 900 may also include processing circuitry, e.g. microprocessor 952, antenna and other components as will be further discussed below. These components may be located behind the contact pad 920 or elsewhere on the substrate 910, e.g. within a different layer of the substrate 910. The transaction card 900 may also include a magnetic strip or tape, which may be located on the back of the card. The transaction card 910 may also include an NFC 954 device coupled with an antenna capable of communicating via the NFC protocol. Embodiments are not limited in this manner.

The contact pad 920 may include or be coupled with an integrated chip 925 for storing and processing information, including a microprocessor 952 including processing circuitry, and memory 956. It is understood that the integrated chip 925 may contain additional components, including processors, memories, error and parity/CRC checkers, data encoders, anticollision algorithms, controllers, command decoders, security primitives, and tamper-proofing hardware, as necessary to perform the functions described herein. Although illustrated as part of or behind the contact pad 920, embodiments are not limited in this manner. In some instances, the integrated may be located in a different location of the transaction card 900 and be coupled with the contact pad 920 via one or more traces or interconnects to enable communication via EMV.

The memory 935 may be any type of memory including, but not limited to, read-only memory, write-once read-multiple memory or read/write memory, e.g., RAM, ROM, and EEPROM, and the transaction card 900 may include one or more of these memories. In some instances, the transaction card 900 may include more than one type of memory and may include encrypted and unencrypted capable memory. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programmed many times after leaving the factory. It may also be read many times.

The memory 935 may be configured to store data, including one or more such as transaction card information, one or more restrictions, and one or more applets 958 having instructions to process data. The one or more applets 958 may include one or more software applications configured to execute on transaction card information and restrictions, such as Java Card applet. However, it is understood that applets 958 are not limited to Java Card applets, and instead may be any software application operable on transaction cards or other devices having limited memory.

In embodiments, the transaction card 900 may also include an NFC device 954 capable of communicating in accordance with an NFC protocol. The NFC device 954 may operate passively and may be energized by a signal emitted by an NFC device of the computing device. The NFC device 954 may draw its power from the electromagnetic field caused by the NFC device of the computing device, for example. However, embodiments are not limited in this manner. In another example, the transaction card 900 may be provided with a power source (not shown) operable to supply power to the NFC device 954 such that it can activate its own electromagnetic field. As discussed herein, the NFC device 954 may be operable to communicate information and data with other devices, such as a mobile device and/or a server to perform one or more transactions using shared transaction card information.

In some examples, the transaction card 900 may include one or more antennas (not shown). The one or more antennas may be placed within the transaction card 900 and around the integrated chip 925 and the contact pad 920. For example, the one or more antennas may be integral with the processing circuitry 925 and the one or more antennas may be used with an external booster coil. As another example, the one or more antennas may be external to the contact pad 920 and the processing circuitry 952. In embodiments, the one or more antennas may be coupled with the NFC device 954 and be configured to enable NFC communication.

The various elements of the devices as previously described with reference to FIGS. 1-9 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

1. A mobile device, comprising:
a processor circuit;
a communication interface; and
a memory storing instructions which when executed by the processor circuit, cause the processor circuit to:
determine, by an application operable on the processor circuit, a first user device associated with a first user with which to share transaction card information, the transaction card information comprising a number associated with an account of a second user, and the transaction card information capable for use to perform one or more transactions;
determine, by the application, one or more restrictions to apply to usage of the transaction card information when shared with the first user device associated with the first user, wherein the one or more restrictions comprises a monetary amount set for the transaction card information to perform the one or more transactions by the first user device, a location in which the transaction card information is used for to perform the one or more transactions, a device restriction to limit use of the transaction card information to the first user device, or a combination thereof;
communicate, by the application via the communications interface and with the first user device, the transaction card information;
communicate, by the application, to a server the transaction card information and the one or more restrictions, the server associated with a provider of the transaction card information, and the one or more restrictions comprising restriction instructions to direct the server to enforce against the one or more transactions; and
receive, by the application and from the first user device, a confirmation that the transaction card information is successfully shared with the first user device.

2. The mobile device of claim 1, wherein the communication interface comprises a near-field communication (NFC) interface, and the first user device comprises a contactless card, and the processor circuit to communicate the transaction card information with the contactless card via the NFC interface.

3. The mobile device of claim 2, the processor circuit to:
detect, via the NFC interface, the contactless card based on the contactless card coming within a proximity range of the mobile device;
determine, by the application, an approval to share the transaction card information based on a user input; and
initiate, by the application, communication of the transaction card information with the contactless card based on the detection of the contactless card and the approval.

4. The mobile device of claim 2, comprising a display device coupled with the processor circuit, the communication interface, and the memory, and the display device to present a virtual contactless card in a graphical user interface (GUI), and the processor circuit to detect, via the NFC interface, the contactless card placed on the display device presenting the virtual contactless card in the GUI.

5. The mobile device of claim 1, wherein the communication interface comprises one of a near-field communication (NFC) interface, a Bluetooth interface, or a WiFi interface, and the first user device comprises a second mobile device, the processor circuit to communicate the transaction card information with the second mobile device via one of the NFC interface, the Bluetooth interface, and the WiFi interface.

6. The mobile device of claim 5, the processor circuit to:
detect, via one of the NFC interface, the Bluetooth interface, or the WiFi interface, the second mobile device based on a received communication;
determine, by the application, an approval to share the transaction card information with the second mobile device based on a user input; and
initiate, by the application, the communicating of the transaction card information with the second mobile device based on the detection of the second mobile device and the approval.

7. The mobile device of claim 1, wherein the one or more restrictions further comprises a time limit restriction including an amount time the transaction card information is enabled for use by the first user device.

8. The mobile device of claim 1, comprising an input device coupled with the processor circuit, the communications interface, and the memory, the input device to receive a user input identifying at least one of an identifier of the first user, a telephone number associated with the first user, and an email address associated with the first user, and
the application, operable on the processor circuit, to determine the first user device associated with the first user to share the transaction card information based on the user input.

9. The mobile device of claim 1, the transaction card information further comprising a name associated with the account, an expiration date associated with the account, and a Card Verification Value (CVV) number associated with the account, and
the processor circuit to encrypt the transaction card information with a public key prior to sharing the transaction card information with the first user device.

10. The mobile device of claim 9, wherein the number associated with the account is a virtual number to share in a single instance with the first user device.

11. The mobile device of claim 9, the processor circuit to communicate with at least one of the server and the first user device to determine the public key to encrypt the transaction card information, wherein the public key is associated with the first user device and the account.

12. A computer-implemented method, comprising:
determining transaction card information to share with a contactless card, wherein the contactless card is associated with a first user, and the transaction card information comprising an account number associated with a second user;
determining one or more restrictions for the transaction card information to apply during performance of one or more transactions;
presenting, on a display device of a mobile device, a virtual contactless card comprising an indicator in a graphical user interface (GUI), the indicator to indicate a location to place the contactless card on the display device;
detecting, via a near-field communication (NFC) interface, the contactless card based on the contactless card coming within a specified distance of the mobile device;
communicating, in response to detecting the contactless card, the transaction card information and an indication of the one or more restrictions to the contactless card, and the one or more restrictions comprising instructions to enable the performance of the one or more transactions by the contactless card; and
receiving, from the contactless card associated with the first user, a confirmation that the transaction card information and the indication of the one or more restrictions are successfully shared with the contactless card.

13. The computer-implemented method of claim 12, wherein communicating and receiving is performed in accordance with an NFC protocol over the NFC interface.

14. The computer-implemented of claim 13, comprising:
detecting the contactless card based one or more signals received from the contactless card in accordance with the NFC protocol;
detecting, based on a user input, an approval to share the transaction card information with the contactless card; and
permitting communicating the transaction card information with the contactless card based on the detection of the contactless card and the approval.

15. (canceled)

16. The computer-implemented method of claim 12, wherein a restriction of the one or more restrictions comprises a time limit restriction including an amount time the transaction card information is enabled for use by the contactless card, a monetary amount restriction including an amount the transaction card information is enabled for to perform the one or more transactions by the contactless card, a device restriction to limit use of the transaction card information to the contactless card, a number of transactions limit, and a location restriction in which the transaction card information is enabled for to perform the one or more transactions.

17. The computer-implemented method of claim 12, comprising:
receiving, via an input device, a user selection of an identifier of the first user, a telephone number associated with the first user, an email address associated with the first user, or any combination thereof; and
determining the contactless card associated with the first user to share the transaction card information based on the user selection.

18. The computer-implemented method of claim 12, comprising:
encrypting the transaction card information with a public key prior to communicating the transaction card information with the contactless card, and wherein the transaction card information further comprises a name associated with the account, an expiration date associated with the account, and a Card Verification Value (CVV) number associated with the account.

19. The computer-implemented method of claim 18, comprising:
sending to a server an indication that the transaction card information is being shared with the contactless card, the server associated with a provider of the transaction card information; and
communicating with at least one of the server and the contactless card to determine the public key to encrypt the transaction card information, wherein the public key is associated with the contactless card and the account.

20. A non-transitory computer-readable storage medium storing computer-readable program code executable by a processor to:
receive, via an input device, a user selection of an identifier of a first user, a telephone number associated with the first user, an email address associated with the first user, or any combination thereof;
determine, by an application operable on the processor, a computing device associated with the first user based on the user selection and to share transaction card information, the transaction card information comprising a number associated with an account of a second user, and the transaction card information capable for use to perform one or more transactions;
receive, by the application, a user selection of one or more restrictions to apply to usage of the transaction card information when shared with the computing device associated with the first user, wherein the one or more restrictions comprises a monetary amount set for the transaction card information to perform the one or more transactions by the computing device, a location in which the transaction card information is used for to perform the one or more transactions, a device restriction to limit use of the transaction card information to the computing device, or any combination thereof;
communicate, by the application via a communications interface, the transaction card information to the computing device;
communicate, by the application, the one or more restrictions and an indication that the transaction card information is shared with the computing device to a server associated with a banking system; and
receive, by the application and from the computing device, a confirmation that the transaction card information was successfully shared with the computing device.
